(19) United States
(12) Patent Application Publication
(10) Pub. No.: US 2012/0204206 A1
(43) Pub. Date: Aug. 9, 2012

(54) SYSTEM AND METHOD FOR CONTROLLING ACCESS TO CONTENTS

(75) Inventors: Luis Miguel Gutierrez Prieto, Madrid (ES); Oscar Mancebo Ortiz, Madrid (ES); Manuel Sanchez Yangüela, Madrid (ES)

(73) Assignee: TELEFONICA, S.A., Madrid (ES)

(21) Appl. No.: 13/388,946

(22) PCT Filed: Aug. 4, 2010
(86) PCT No.: PCT/EP10/61328

§ 371 Date: Apr. 20, 2012

(30) Foreign Application Priority Data
Aug. 4, 2009 (ES) P200930560
Nov. 16, 2009 (ES) P200930991

(51) Int. Cl. H04N 21/2347

(52) U.S. Cl. 725/31

(57) ABSTRACT

The invention relates to a system and method for controlling access to contents. The system comprises a network for distributing encrypted content, a receiver (100) for receiving such content, at least one mobile terminal (200) for communicating with the receiver (100) through a short-range wireless interface, for example NFC, means for sending the Identifier of the desired Content, Product or Service and a user identification from the smart card of the mobile terminal (200) to a purchase platform (300) and means for sending the information necessary for decoding the encrypted content to the smart card of the mobile terminal (200). The mobile terminal (200) is configured to send said information through the wireless interface to the receiver (100) and the receiver (100) decodes the encrypted content with the aid of the information received from the mobile terminal (200). Smart cards with SCWS technology are used.

### TECHNICAL FIELD OF THE INVENTION

The present invention relates to the communications sector in general, and more particularly to the broadcasting area.

### BACKGROUND OF THE INVENTION

Up until now, all TV distribution services in digital format, either IPTV (Internet Protocol Television) on optical accesses or xDSL accesses (the different asymmetric digital line modes), or digital content distribution services on cable networks, involve the need for an additional external decoder. This involves high operational costs, because it is necessary to have the logistics for the distribution of the decoders and a register of the decoders is necessary in order to identify, in the event of problems, which clients must have their decoder replaced. Also, the actions on the decoders to migrate services of this type are expensive.

Furthermore, digital content distribution services have been deployed by developing provision systems for users, client equipment configuration and ad-hoc equipment management for services of this type, unrelated to the provision, configuration and management systems already available for another type of services provided by the same operator, which involves new costs in investments as well as in operational expenses.

There are three technological aspects of content distribution services which have not been solved up until now.

Firstly, content distribution services, except in the case of IPTV services on accesses by means of an asymmetric digital line (xDSL), are based on point-to-multipoint accesses, either on a radio interface, on cable or on optical fiber. This point-to-multipoint topology means that pay contents, as well as any hiring of goods or services, reach all the users, both those who have hired it and those who have not, which opens up the door to fraud, an undesirable aspect for content providers.

Secondly, up until now they do not allow mobility, since the service is linked to the physical access hired by the user.

Thirdly, they do not allow a telecommunications operator to be able to act as an intermediary for controlling content distribution services or services for purchasing goods and services by TV (home shopping type) provided by third parties, such as a cable operator.

Patent application EP 1 771 003 A1 discloses an interactive DVB-T (Digital Video Broadcasting-Terrestrial) system which comprises a Service Center for broadcasting composite television signals, formed by television programs with associated specific interactive data, a set-top box for decoding the television program and the interactive data associated with the tuned television channel, one or more GPRS/UMTS mobile telephones short-range located to the set-top box and Bluetooth® interfaces inside the set-top box and the mobile telephones for the communication between them. The set-top box sends a list with the selection options to the authorized mobile telephones around it through a Bluetooth® channel. The mobiles show the list on the screen and the option selected by the user is sent to the service provider through a GPRS/UMTS channel.

### DESCRIPTION OF THE INVENTION

An objective of the invention is to provide a system and corresponding method, which minimize the intervention of the user in the decoding of the content received by the set-top box.

To that end, according to the invention a system according to independent claim 1 and a method according to independent claim 10 are provided. The dependent claims describe particular embodiments of the invention.

According to an aspect of the invention, a system for controlling access to contents is provided, said system comprises a network for distributing an encrypted content, at least one receiver for receiving the encrypted content and at least one mobile terminal configured to communicate with the receiver through a wireless interface. The system comprises means for sending the Identifier of the desired Content, Product or Service, hereinafter referred to as IDCPS, together with a user identification from the smart card of the mobile terminal to a platform of a cellular communications network and means for sending the information necessary for decoding the encrypted content to the smart card of the mobile terminal through the cellular communications network. The mobile terminal is configured to send said information through the wireless interface to the receiver. The receiver is configured to decode the encrypted content with the aid of the information received from the mobile terminal.

With the system according to the invention, the intervention of the user in the decoding process is minimized. If the wireless interface is an NFC (Near Field Communications) interface, the user must only move the mobile terminal closer to the controller of the receiver of the encrypted content. The smart card is an element belonging to the operator, not to the user, and has process and storage capability. It can therefore be used to generate the required information (messages, keys and/or seeds for generating keys) in a completely transparent manner for the user (and the mobile terminal in which it is housed) without the user having access thereto. Therefore, the information necessary for decoding the encrypted content is not accessible to the user and at no time is it stored in his terminal.

The system preferably comprises means located in the receiver for sending the IDCPS, previously selected by the user through a menu shown on the receiver screen, to the smart card of the mobile terminal. However, it is also possible for the user to select the IDCPS browsing through a menu shown in the mobile terminal.

According to an embodiment, the information necessary for decoding the encrypted content comprises the key which must be used to decode it.

The identification of the receiver can form part of the seed used to generate the key.

According to an alternative embodiment the information necessary for decoding the encrypted content comprises an indication of a key already stored in the receiver which the latter must use to decode the content.

The mobile terminal preferably comprises a microcontroller for communicating with the receiver through the wireless interface, and the means for sending the IDCPS and the user identification comprise a MIDlet or Java 2 Micro Edition application allowing the interaction of the mobile terminal with the receiver and with the cellular communications network and an Applet or JavaCard application in the smart card allowing the identification of the user, stored in the smart card by the MIDlet.

The wireless interface between the receiver and the mobile terminal can be of any suitable type, for example NFC or Bluetooth®.

The receiver for receiving the encrypted content is preferably a Digital Terrestrial Television receiver.

In a second proposed option, the need for a MIDlet or J2ME (Java 2 Micro Edition) application in the mobile terminal for allowing the interaction between the terminal, the user, the DTT receiver and the mobile telephony network is eliminated. On the contrary, according to the present invention smart cards with SCWS (Smart Card Web Server) technology are used.

SCWS is a JavaCard application residing in the UICC, which implements an HTTP (HyperText Transfer Protocol) server. This technology provides to the users the access to content and applications in the UICC card in a homogeneous manner, i.e., without the terminal used being important. Therefore, SCWS is a server which operates within the UICC card and which is portable from one mobile terminal to another. It provides static and dynamic web pages and allows transactions between the card and applications based on HTTP, which operate in the mobile terminal, for example a web browser. Using SCWS, an application installed in the UICC card can benefit from the user interface and from the multimedia capabilities of a browser.

The incorporation of a SCWS smart card in the mobile terminal allows the communication between the smart card of the mobile terminal and the purchase platform and provides the user interface for the selection of the content. Therefore, the MIDlet or J2ME (Java 2 Micro Edition) application in the mobile terminal for allowing the interaction between the terminal, the user, the receiver and the mobile telephony network can be omitted. Furthermore, the content can be selected through the mobile terminal due to the user interface of the browser of the mobile terminal and not through the receiver of the content.

According to an embodiment of the invention, the content can be displayed in any receiver suitable for receiving the encrypted content which incorporates a wireless interface for communicating with the mobile terminal. It is only necessary to send the key for decoding the encrypted content from the mobile terminal to the receiver. According to an embodiment of the invention, said key is delivered through NFC, although another short-range wireless interface such as Bluetooth® can also be used. The encrypted content can be displayed in any receiver because the receiver identification is not sent from the mobile terminal to the purchase platform and therefore said information is not part of the seed for generating the key which must be used to decode the content. A single-use seed can be generated in order to control that the content can only be displayed in a single receiver.

According to another aspect of the invention, a method for controlling access to contents is provided, which method comprises the steps of: distributing an encrypted content through a network; at least one receiver receiving the encrypted content; and at least one mobile terminal communicating with the receiver through a wireless interface, characterized in that the method comprises: sending the Identifier of the desired Content, Product or Service together with a user identification from the smart card of the mobile terminal to a platform of a cellular communications network; sending the information necessary for decoding the encrypted content to the smart card of the mobile terminal through the cellular communications network, sending said information from the mobile terminal through the wireless interface to the receiver and the receiver decoding the encrypted content with the aid of the information received from the mobile terminal.

### DESCRIPTION OF THE DRAWINGS

The invention will be better understood and its numerous objectives and advantages will be more evident for the persons skilled in the art with reference to the following drawings, together with the specification attached thereto, in which:

FIG. 1 shows the proposed improvement according to an embodiment of the invention on the standard diagram of a DTT receiver.

FIG. 2 shows the mode of operation of the system according to an embodiment of the invention.

FIG. 3 shows a part of the mode of operation, according to a preferred embodiment, shown in FIG. 2 in more detail.

FIG. 4 shows the field of application of the invention.

FIG. 5 shows the mode of operation, according to a preferred embodiment of the present invention.

In all the figures the same reference numbers refer to identical elements.

### PREFERRED EMBODIMENTS OF THE INVENTION

In view of the figures discussed, a practical embodiment of the invention can be described herein. According to this embodiment, the evolution of a Digital Terrestrial Television, DTT, receiver (DVB-T, or Digital Video Broadcasting-Terrestrial) is proposed for its conversion into a decoder for services of Pay-per-View, TV packages, and generally, for any type of purchase of goods and services advertised through DTT. To that end, an NFC (Near Field Communications) microcontroller is included in the receiver. The inclusion of an NFC control elements allows the DTT receiver to communicate with a smart card (UICC, Universal Integrated Circuit Card, for example a SIM card) integrated in a mobile telephone, and obtain the credentials of the user and the information necessary for decoding the encrypted pay contents, or for hiring the goods and services of interest.

This mode of identification and configuration of the decoding integrated in a DTT receiver can be used to, in combination with the mobile payment platform and the smart card (UICC) of an operator based on NFC, rapidly deploy pay TV services reusing the capabilities of the network of an integrated communications operator, including a “nomadic” billing of multimedia contents, without needing additional external elements. To that end, an NFC microcontroller with the capacity to operate in read/write mode is incorporated to the DTT receiver, and a mobile terminal with NFC capabilities which can interact with the UICC card is used.

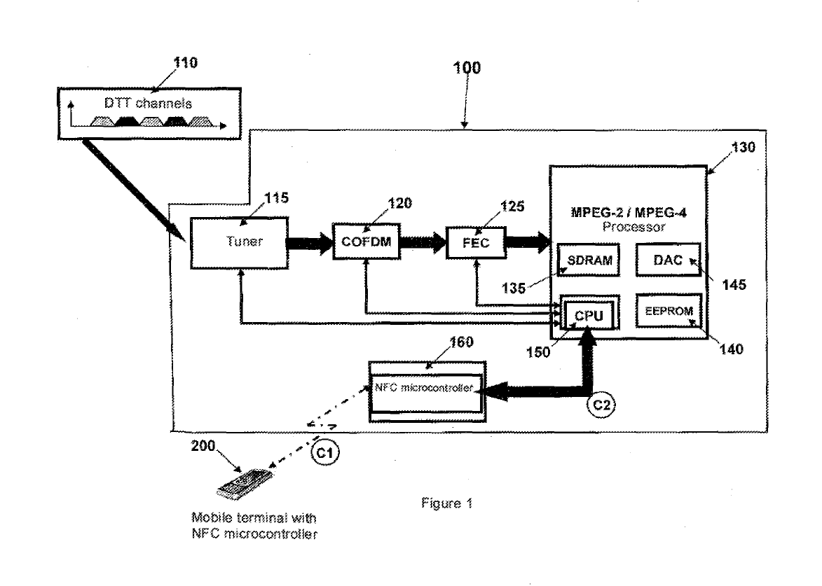

As has already been stated, this evolution facilitates the development and deployment of new services, such as purchase services through DTT and the mobile network. In this case, and using only some of the channels distributed by DTT as a catalog of selection of products/services, the NFC control element included in the receiver allows selecting the item to be acquired/hired and obtain the credentials for making the payment securely and reliably through the mobile network of the integrated operator. The diagram shown in FIG. 1 includes an outline of an embodiment of the invention. The figure shows a DTT receiver 100 receiving DTT channels 110 and comprising the following already known elements: a tuner 115, a COFDM (Coded Orthogonal Frequency Division Multiplexor) circuit 120, an FEC (Forward Error Correction) circuit 125, a MPEG-2/MPEG-4 processor 130, an SDRAM (Synchronous Dynamic Random Access Memory) memory 135, an EEPROM (Electrically Erasable Programmable Read-Only Memory) memory 140, a digital-analog converter, DAC 145 and a central processing unit, CPU 150. The proposal consists of incorporating an NFC microcontroller 160 to the DTT receiver 100. This microcontroller 160 exchanges information C1, on one hand, with the mobile terminal 200 with the NFC microcontroller and, on the other hand, C2, with the Central Processing Unit 150 of the processor of the DTT receiver 100. The inclusion of the NFC microcontroller 160 thus provides the DTT receiver 100 with new capabilities which can be controlled from the UICC card 210 of the mobile terminal 200, and which can therefore be controlled from the network of a communications operator 300. A secure communication channel between the DTT receiver 100 and the network of the operator 300, which can be used for acquiring contents, goods or services, is thus enabled.

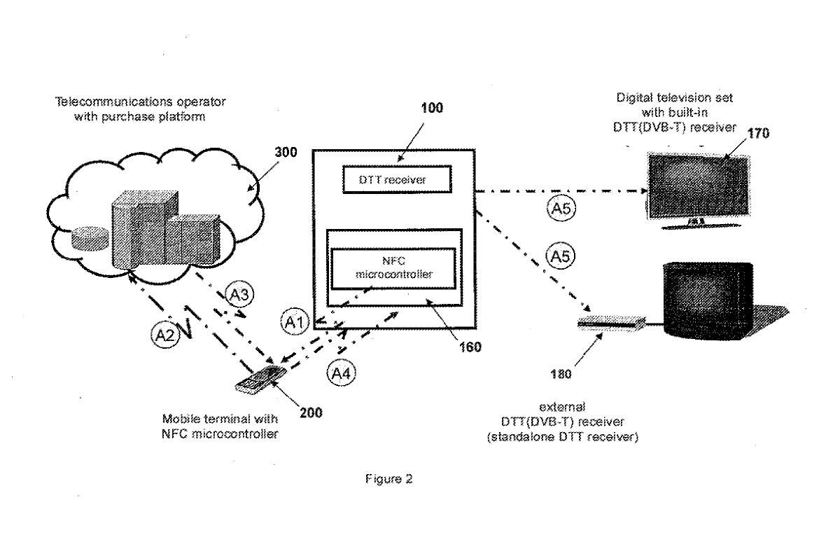

FIG. 2 shows the mode of operation of the DTT receiver 100 with the NFC microcontroller 160 incorporated, the mobile terminal 200 and the purchase platform 300 (which is in charge of the control and the billing of the contents) of the network of the telecommunications operator. The DTT receiver 100 can be part of a digital television set with a built-in DTT receiver 170 or can be an external DTT receiver of an analog television set 180.

The mobile terminal 200 proceeds A1 to identifying the DTT receiver 100 through which the content is to be displayed (HARDWARE ID, such as the serial number for example). This piece of data is stored in the secure element of the NFC microcontroller 160 of the DTT receiver 100. Said identification is used an additional element in the decoding process for a multimedia content since it is used as a seed for generating the decoding key. The identification of the channel can be carried out from the decoder or from the mobile terminal. In the first case, the channel identifier is sent at the same time as the receiver identifier. In the second case, the selection is carried out from a menu in the mobile terminal, which already has the channel identifier.

The user uses the browsing guide offered by the service to select the purchase of a content or product. In the moment in which the user commences the purchase, the MIDlet 220 installed in the mobile terminal 200 described below generates a secure purchase request message A2 to the platform 300 of the network with the following data:
The identification of the DTT receiver 100 (HARDWARE ID) stored in the NFC microcontroller 160 obtained in A1. The identification of the user (USERID) associated with the MSISDN or Mobile Station International Subscriber Directory Number, stored in the UICC 210 of the mobile terminal 200.
An Identifier of the Content, Product or Service (IDCPS), manually selected by the user. In the case of a multimedia content, the IDCPS identifier must include the identification of the DTT channel and the broadcasting time of the program.

When the purchase platform 300 receives the purchase request A2, it first identifies the user (USERID) and verifies the MSISDN associated therewith, and then generates a message A3 the destination of which is said MSISDN 210. This message A3, with the information required by the DTT receiver 100 to be able to allow displaying the content, is coded by the operator 300 and goes directly to the UICC 210, without passing through the terminal 200, and it is a message to which the user has not got access and, therefore, cannot access the content of the message. Said information is preferably the key used to encrypt the content and which must be used to decipher it. However, it can also be an indication of a key already stored in the DTT receiver 100 which the latter must use to decipher the content. At the same time, the platform 300 has the information necessary for billing for the content.

Once the UICC 210 has received the message A3, (an event which can be notified to the user, for example, by means of a visual indication), the user must only move the mobile terminal 200 closer (about 4 cm) to the NFC controller 160 of the DTT receiver 100. The mobile terminal 200 sends to the NFC microcontroller 160 A4 through NFC the information A3 received from the platform 300, which consists of the key which must be used to decipher the content. Finally, the DTT receiver 100 applies said key for the decoding A5 and allows displaying the content. For the case of purchasing a good or service, A4 and A5 are not necessary.

This purchase mechanism inherently incorporates the mobility: the purchasing user can be a visitor different from the proprietor of the DTT receiver.

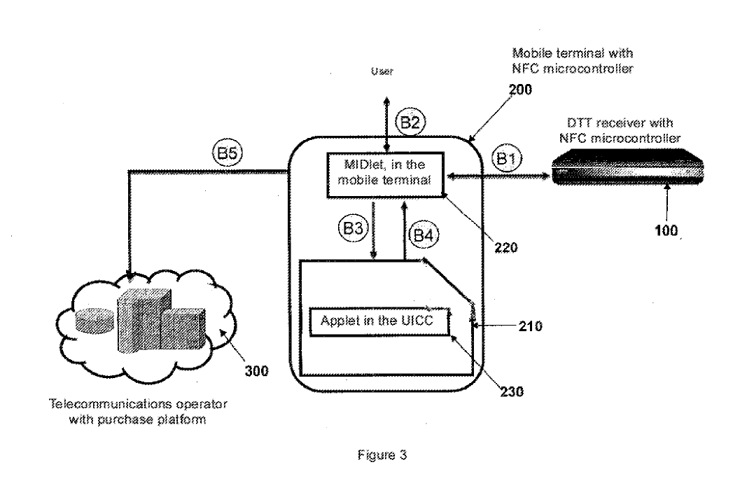

FIG. 3 details the mode of operation of A1 and A2 of FIG. 2. Specifically, in addition to the NFC microcontroller 160 added to the DTT receiver 100, a MIDlet or J2ME (Java 2 Micro Edition) application 220 in the mobile terminal 200, allowing the interaction of the latter with the DTT receiver 100 and with the network of the telephony operator 300, is required. Furthermore, an Applet 230, a JavaCard application in the UICC 210 belonging to the operator, which allows consulting the credentials of the user USERID, stored in the UICC 210 by the MIDlet 220 of the mobile terminal 200, is required.

The MIDlet 220 identifies the DTT receiver 100 through which the content is to be displayed, B1. The MIDlet 220 requests the IDCPS from the user, B2. The MIDlet 220 communicates with the Applet 230 of the UICC 210 to obtain the client identifier USERID, B3. The Applet 230 returns the client identifier USERID, stored in the UICC card 210, B4. The MIDlet 220 then constructs a secure message B5 with the following identities: HARDWAREID, IDPCS and the USERID.

A specific DTT channel providing the potential clients with the identifiers of the multimedia pay contents and possibly with other products and services which can be hired by means of this system is required. These identifiers are those which the client must enter at the request of the MIDlet 220 of the mobile terminal 200 when he wishes to make a purchase.

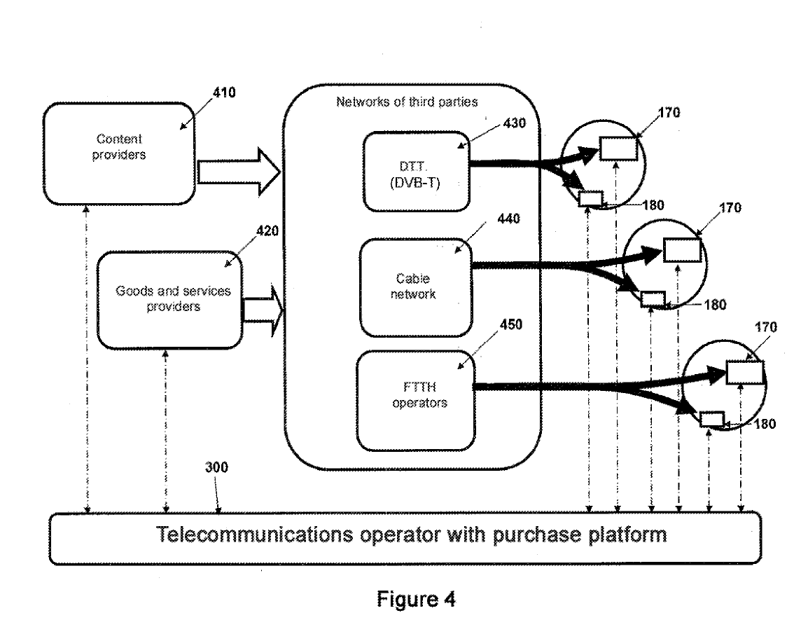

Finally, FIG. 4 shows the mode in which a telecommunications operator 300 can, by means of the improvements contemplated according to the present invention, control and bill for the distribution of contents, goods and/or services, even when they are contents or goods and services of external providers 410, 420 and the distribution is done through the network of third parties, for example a DTT network 430, a cable network 440 or an FTTH (Fiber To The Home) network 450.

Another preferred embodiment of the invention is described below. According to this embodiment, it incorporates a UICC card, allowing SCWS technology in a mobile terminal, to facilitate the interaction between the terminal and the user and to facilitate the communication with the DTT receiver and the cellular communication network. Said communication is essential for facilitating the evolution of a DTT receiver for its conversion into a decoder for services of Pay-per-View, TV packages, and generally for any type or purchase of goods and services advertised through DTT.

The overall operation of the system is basically the same as in the previous practical embodiment. The system comprises a network for distributing encrypted content, a receiver for receiving such content, at least one mobile terminal for communicating with the receiver through a short-range wireless interface, for example NFC, means for sending the Identifier of the desired Content, Product or Service (IDCPS) and a user identification from the smart card of the mobile terminal to a platform of a cellular communications network and means for sending the information necessary for decoding the encrypted content to the smart card of the mobile terminal through the cellular communications network. The mobile terminal is configured to send said information through the wireless interface to the receiver and the receiver decodes the encrypted content with the aid of the information received from the mobile terminal.

The main difference with said previous practical embodiment is the use of UICC cards with SCWS technology. The need for a MIDlet or Java 2 Micro Edition application in the mobile terminal for allowing the interaction between the terminal, the user, the DTT receiver and the mobile telephony network is thus eliminated.

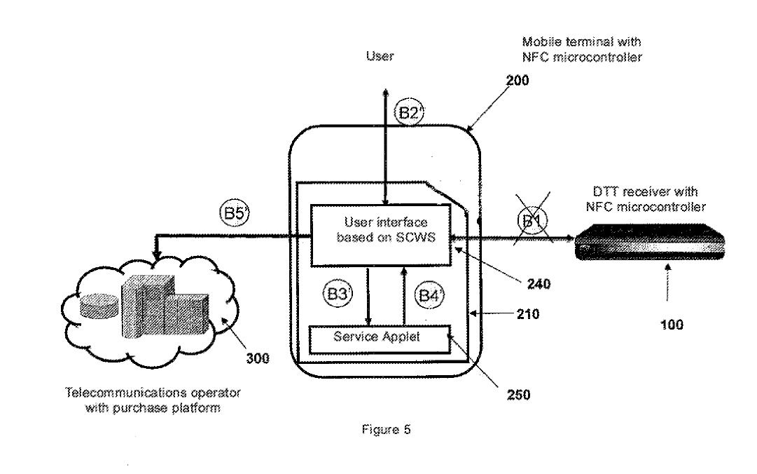

FIG. 5 shows the mode of operation between the mobile terminal 200 and the telecommunications operator with a purchase platform 300. Specifically, in addition to the NFC microcontroller incorporated in the DTT receiver, a user interface Applet (JavaCard application) based on SCWS 240 in the UICC card 210 belonging to the operator is required. Said Applet allows the interaction with the user and the communications operator 300. Likewise, a service Applet 250 (JavaCard application), which allows obtaining the client identifier USERID stored in the UICC card 210 and which must be sent by the user interface applet 240, when the content is requested, is required.

Through the user interface applet 240, the access guide for selecting the desired content is displayed B2′ to the user. The updates of the contents broadcast on TV are received in the UICC card from the cellular communication network (the EPG program schedule is received).

Therefore, unlike the system according to the previous practical embodiment, it is not necessary for the DTT receiver to provide the Identifier of the desired Content, Product or Service (CPSID), because the latter is stored in the UICC card 210.

Furthermore, the same user interface applet 240 communicates B3′ with the service Applet 250 to obtain the user identification USERID. The service Applet 230 returns B4′ said user identification USERID stored in the UICC card 210. The user interface applet 240 then generates a secure message B5′ with the following identities: CPSID and USERID. Unlike the previous practical embodiment, it is not necessary to identify B1 the DTT receiver in which the content is to be seen. Therefore, the content can be seen in any DTT receiver configured for this purpose. Consequently, said identification is not used to generate the secure message because the platform 300 does not use it as a seed for generating the decoding key. However, the generated seed is valid for a single use and the content can therefore only be displayed through a single receiver.

In the same way as in the system according to said previous practical embodiment, when the purchase platform 300 receives the secure message B5′ generated by the UICC 210 with SCWS technology, it first identifies the user (USERID) and verifies the MSISDN associated therewith, and then it generates a message the destination of which is said MSISDN 210. This message goes directly to the UICC 210, without passing through the terminal 200, and is coded by the operator 300 with the information required by a DTT receiver 100 with an NFC microcontroller 160 to be able to allow displaying the content. To see the content, the user must only move the mobile terminal 200 closer to the NFC controller 160 of the DTT receiver 100.

The present invention provides a new option for deploying content distribution services, in standard quality (SDTV or Standard Definition TV) and in high definition (HDTV or High Definition TV), pay-per-view (PPV) television, provided from the network of an integral telecommunications operator, without needing an additional decoder in the DTT receiver, and reusing the pay platforms of the integrated operator.

This application is valid both in the case of standalone DTT decoders 180 for analog television sets and in the case of built-in DTT receivers 170 in new digital television sets, providing the DTT receiver with an NFC microcontroller.

This opens up two new commercial scenarios for an integral telecommunications operator:
If the telecommunications operator itself is the broadcaster, the one distributing the DTT signal, either through a radio interface (DVB-T), through an HFC (Hybrid Fiber-coaxial) cable network or through an FTTH optical access network based on GPON through the enhancement band (UIT-T G.984.5 standard), the application is immediate: on said distribution services, and using the mobile terminal as an element for control by the user, a marketing service for multimedia contents or for products and services (of the homeshopping type) can be provided using the control and billing platforms of his mobile telephony network as the support.
If it is not the distributor of the contents, it can benefit as an operator of the mobile service which provides the credentials, in order to decode or acquire the contents, or the goods and services, offered by third parties, and which is furthermore in charge of billing for said contents or goods and services, acting as a trusted party between the client and the distributor.

The DVB-T standards are open and contemplate mechanisms for updating the firmware of the DTT receivers, therefore the solution considered is open and can evolve to the extent that the DVB-T standards do. The availability of a communication channel between the DTT receiver and the network of the operator offers a route for this update of the firmware of the DVB-T receivers.

Although the invention has been illustrated and described in detail in the drawings and in the previous description, such illustration and description must be considered as illustrative or as examples and as non-restrictive; the invention is not limited to the disclosed embodiments.

Naturally, the invention can be implemented with content broadcasting technologies other than DTT. The communication between the mobile terminal 200 and the DTT receiver 100 can also be through a wireless communication interface other than NFC, for example Bluetooth®. The persons skilled in the art can understand and carry out other variations of the disclosed embodiments by putting into practice the claimed invention, from an analysis of the drawings, the specification and the attached claims. In the claims, the term “which comprises” or “comprising” does not exclude other elements or steps, and the indefinite article “a” or “an” does not exclude a plurality. A single processor or another unit can fulfill the functions of various elements listed in the claims. The mere fact that certain measures are mentioned in different mutually dependent claims does not indicate that a combination of these measures cannot be used advantageously. A computer program can be stored/distributed on a suitable medium, such as an optical storage medium or a solid state medium supplied together with or as part of another hardware, although it can also be distributed in other forms, such as through Internet or other cable or wireless telecommunication systems. No reference symbol in the claims must be interpreted as limiting the scope.

1. System for controlling access to contents which comprises:
a network (430, 440, 450) for distributing an encrypted content; at least one receiver (100) for receiving the encrypted content; at least one mobile terminal (200) configured to communicate with the receiver (100) through a wireless interface, wherein the system comprises:
means (220, 230, 240, 250) for sending the Identifier of the desired Content, Product or Service, hereinafter referred to as IDCPS, together with a user identification from the smart card (210) of the mobile terminal (200) to a platform of a cellular communications network (300);
means for sending the information (A3) necessary for decoding the encrypted content to the smart card (210) of the mobile terminal (200) through the cellular communications network (300) wherein the mobile terminal (200) is configured to send said information (A4) through the wireless interface to the receiver (100) and wherein the receiver (100) is configured to decode the encrypted content with the aid of the information (A4) received from the mobile terminal (200).

2. System according to claim 1, wherein it comprises means (160) located in the receiver (100) for sending the IDCPS to the smart card (210) of the mobile terminal (200).

3. System according to claim 1, wherein the means (240,250) for sending the IDCPS, together with the user identification from the smart card (210) of the mobile terminal (200) to the platform of a cellular communications network (300) comprise an application (240) loaded in the smart card (210), which implements a web server.

4. System according to claim 3, wherein the application loaded in the smart card (210) provides the user interface for selecting the desired Content, Product or Service.

5. System according to any of claim 1, wherein the information (A3) necessary for decoding the encrypted content comprises the key which must be used to decode it or a seed for generating said key.

6. System according to claim 5, wherein the identification of the receiver (100) does not form part of the seed for generating the key which must be used to decode the content.

7. System according to claim 6, wherein the seed for generating the key is a single-use seed.

8. System according to claim 2, wherein the means (160) for sending the IDCPS to the smart card (210) of the mobile terminal (200) are configured to also send the identification of the receiver (100), the means (220,230) for sending the identification of the receiver and the IDCPS together with a user identification from the smart card (210) to a platform of a cellular communications network (300) are configured to also send the identification of the receiver (100), wherein the identification of the receiver (100) forms part of the seed used to generate the key which must be used to decode the content.

9. System according to claim 1, wherein the information (A3) necessary for decoding the encrypted content comprises an indication of a key already stored in the receiver (100) which the latter must use to decode the content.

10. System according to claim 9, wherein the mobile terminal (200) comprises a microcontroller for communicating with the receiver (100) through the wireless interface, and in that the means (220,230) for sending the IDCPS and the user identification comprise a MIDlet or Java 2 Micro Edition application (220) allowing the interaction of the mobile terminal (200) with the receiver (100) and with the cellular communications network (300) and an Applet or JavaCard application in the smart card (210) allowing the identification of the user, stored in the smart card (210) by the MIDlet (220).

11. System according to claim 1, wherein the wireless interface is an NFC interface.

12. System according to claim 1, wherein the wireless interface is a Bluetooth® interface.

13. System according to claim 1, characterized in that the receiver (100) for receiving the encrypted content is a Digital Terrestrial Television receiver.

14. Method for controlling access to contents which comprises the steps of:
distributing an encrypted content through a network (430, 440, 450);
at least one receiver (100) receiving the encrypted content;
at least one mobile terminal (200) communicating with the receiver (100) through a wireless interface,
wherein the method comprises:
sending (A2) the Identifier of the desired Content, Product or Service, hereinafter referred to as IDCPS, together with a user identification from the smart card (210) of the mobile terminal (200) to a platform of a cellular communications network (300);
sending (A3) the information necessary for decoding the encrypted content to the smart card (210) of the mobile terminal (200) through the cellular communications network (300),
sending (A4) said information from the mobile terminal (200) through the wireless interface to the receiver (100) and
the receiver (100) decoding the encrypted content with the aid of the information received from the mobile terminal (200).

15. Method according to claim 14, wherein sending (A2) the IDCPS together with the user identification from the smart card (210) of the mobile terminal (200) to the platform of the cellular communications network (300) is carried out by means of an application loaded in the smart card (210), which implements a web server.
